(19) United States
(12) Patent Application Publication
(10) Pub. No.: US 2017/0231018 A1
(43) Pub. Date: Aug. 10, 2017

(54) IPV6 INTERFACE ID FILTER USING A SINGLE PDN CONNECTION

(71) Applicant: NOKIA SOLUTIONS AND NETWORKS OY, Espoo, OT (FI)

(72) Inventors: Wolfgang HAHN, Bergfelde (DE); Seppo Ilmari VESTERINEN, Oulunsalo (FI); John Juha Antero RASANEN, Espoo (FI)

(21) Appl. No.: 15/501,885

(22) PCT Filed: Aug. 6, 2014
(86) PCT No.: PCT/EP2014/066914

§ 371 Date: Feb. 6, 2017

(51) Int. Cl. H04W 76/02; H04W 80/06; H04L 29/12; H04L 29/06

(52) U.S. Cl. CPC H04W 76/02; H04L 69/163; H04W 80/06; H04L 61/6068; H04L 61/2007

(57) ABSTRACT

It is provided a method, comprising monitoring if a second data path is established for a flow, wherein a first internet protocol address is configured for the flow via a first data path between an apparatus performing the method and a packet data network; assigning, if the second data path is established, a second internet protocol address different from the first internet protocol address for the flow via the second data path, wherein at least a part of the first data path belongs to a radio access technology; at least a part of the second data path belongs to the radio access technology; and the part of the first data path is different from the part of the second data path.

### FIELD OF THE INVENTION

The present invention relates to an apparatus, a method, and a computer program product related to data communication. More particularly, the present invention relates to an apparatus, a method, and a computer program product related to multipath TCP with dual LTE connections.

### BACKGROUND OF THE INVENTION

### Abbreviations

3GPP Third Generation Partnership Project
ANDSF Access Network Discovery and Selection Function
AP Access Point, e.g. a radio node in a Wi-Fi network
APN Access Point Name
CN Core Network
DSMIP Dual Stack Mobile IP
eNB evolved NodeB, LTE (EUTRAN) base station
EPC Evolved packet Core
EPS Evolved Packet System
E-RAB EUTRAN Radio Access Bearer
EUTRA Evolved UTRA
EUTRAN EUTRA network
ID Identifier
IETF Internet Engineering Task Force
IFOM IP Flow Mobility
IID Interface ID
IP Internet Protocol
IP-CAN IP Connectivity Access Network
GPRS General Packet Radio Service
GTP GPRS Tunnelling Protocol
GTP-u GTP User plane
GW Gateway
LTE Long Term Evolution
LV Length and Value
M Mandatory
MeNB Master eNB
MCG Master Cell Group
MME Mobility Management Entity
MPTCP Multipath TCP
NAS Non-Access Stratum
NW Network
O Optional
P-GW PDN Gateway
PCO Protocol Configuration Option
PDN Packet Data Network
PLMN Public Land Mobile Network
Pre Prefix
PTI Procedure Transaction Identifier
QoS Quality of Service
RA Radio Access
RAN Radio Access Network
RAT Radio Access Technology
Rel Release (e.g. version of a 3GPP standard specification)
RFC Request for Comments (IETF specification)
S1-u S1 tunnelling interface (typically uses GTP-u)
SCG Secondary Cell Group
SeNB Secondary eNB
S-GW Serving Gateway
TAD Traffic Aggregate Description
TCP Transmission Control Protocol
TFT Traffic Flow Template
TLV Type, Length, and Value
TR Technical Report
TS Technical Specification
TV Type and Value
UDP User Datagram Protocol
UE User Equipment
UMTS Universal Mobile Telecommunications System
UTRA UMTS Terrestrial Radio Access
UTRAN UTRA network
V Value
VoLTE Voice over LTE
Wi-Fi Wireless Fidelity, e.g. defined by IEEE802.11 specifications and/or certified by Wi-Fi Alliance
WLAN Wireless Local Area Network (also named Wi-Fi)

The present application relates to the 3GPP connectivity and multipath TCP (MPTCP) transport. 3GPP connectivity is defined to provide EPS bearer services to a User Equipment (UE) over a radio access network (RAN). EPS connectivity is capable of granting an IP address or multiple IP addresses to a UE, in order the UE to connect to the internet. Conventionally, such a PDN connection might comprise several bearers supporting different QoS and sharing the same IP address.

In 3GPP release 12 study on small cell enhancements for EUTRA and EUTRAN, dual connectivity is described as a solution to serve UE from macro cells and from smaller cells at the same time. The study identifies multiple architectural alternatives, from which option 1A and option 3C were decided to be standardized in the work item, yet in release 12 schedule.

Both options allow to establish two bearers inside a PDN connection that use different path in the radio network, one connecting a UE with a Master eNB (MeNB) and the other transferring at least part of a bearer traffic over a Secondary eNB (SeNB).

MPTCP provides aggregation of multi-path traffic at the upper layers (IP). The “multi-path” should be implemented over two ordinary EPS bearer services.

The current 3GPP specifications support UEs to use multiple bearers sharing the same IP Address. According to these specifications, there is always a default bearer and optionally dedicated bearers. The traffic is separated by traffic flow templates (TFT) that contain filter information describing what traffic should be directed to what bearer (in the UE in UL direction and in P-GW in DL direction). A Filter may contain components like the source and/or destination IP address, port number or a range of port numbers, prefix length (for IPv6 address), security parameter index, type of service/Traffic class, Flow label type (as per 3GPP TS 24.008). Related to each filter there is also an evaluation precedence parameter.

In case of IPv6, the addresses consist of a prefix part (Pre) that is assigned by the network (P-GW) and an interface ID (IID) that is assigned by the device/UE. To be able to use MPTCP, each path is identified in the MPTCP stack by the IP address that represents the network socket/network interface of the device.

In PCT/EP2014/061325, filed Jun. 2, 2014, it was proposed to use different IP addresses also inside a PDN connection. As one option to support MPTCP it is suggested to let the UE assign multiple IPv6 addresses from the address range that belongs to the single IPv6/64 prefix associated to the used PDN connection by assigning only different IPv6 interface identifiers. Such a solution has the advantage to be very much compliant with current procedures and specification and limits the implementation effort. This means different bearers share still the same IPv6 prefix and use only different IID.

According to PCT/EP2014/061325, it possible to use the MeNB access and the SeNB access for dual connectivity, not only in the radio bearer services but additionally also in the IP connectivity. Thus, MPTCP may run over two subflows, one over the MeNB access path and the other over the SeNB access path

The current 3GPP specified IP link model follows the point-to-point IP attachment paradigm. There is a limitation that just a single IPv6 prefix within a PDN connection is allowed. On the other hand, an IPv6 multi-homing UE may establish another PDN connection. Multi-homing means that UE is granted multiple independent addressable IP addresses to be valid simultaneously. According to PCT/EP2014/061325, the UE may, for this reason, request from the 3GPP P-GW multiple IP address for the establishment of multiple PDN connections, each connection having an own IP address. The P-GW may grant and assign UE, at the UE request, multiple PDN connections and multiple IP addresses. In this manner, the limitation of the prior art is overcome.

According to PCT/EP2014/061325, the small cell architecture enhancement option 1A in 3GPP supports LTE dual connectivity via two base stations such as a Master eNB (MeNB) and a Secondary eNB (SeNB). In these embodiments, the UE sees two radio interfaces and two data paths. The bearers served by MeNB and the bearers served by SeNB are separate, and according to the invention they need to be coupled together in order to serve a MPTCP connection. According to some embodiments of the invention, these bearers serve different PDN connections, the PDN connections of which have a different IP point of attachment, i.e. they are served by a different IP address.

According to PCT/EP2014/061325, the default EPS bearer may be via the MeNB as the primary data path, and, when available and/or required (e.g. because of capacity requirements), an additional “booster” EPS bearer is via the SeNB as the secondary data path. Thus, a MPTCP connection is set up over these bearers.

In order to operate the MPTCP, the UE uses different IPv6 addresses for each interface/data path, so that UE uses multiple IPv6 addresses within a single PDN connection. In particular, if the UE desires MPTCP connections, the UE may request and thereafter configure different IPv6 addresses to the default EPS bearer and to the “booster” EPS bearer. An UE may also use two bearers of type “default EPS bearer”. When using the booster bearer, its bearer parameters, for example quality of service parameters, may be the same as the parameters of the default EPS bearer or different from the parameters of the default EPS bearer. When using two default EPS bearer types, their parameters may be equal or they may be different. In some embodiments of the invention, a booster bearer may inherit some or all of the bearer parameters from the default EPS bearer. In this manner, the booster bearer yet provides boosting, because it uses different radio resources, capacity and a different data path than the default EPS bearer in dual connectivity. In contrast to that, conventionally, a booster bearer having the same parameters as the default bearer would not boost because it uses the same resources as the default bearer.

The UE may set up a MPTCP connection with a server, when both of them support MPTCP connection. MPTCP first executes the initial TCP connection setup using one IP address and then it further sets up additional subflows to use the other IP address(es) to form a MPTCP connection. Once having the MPTCP connection running over two (or more) IP addresses, over the two (or more) bearers, the MPTCP protocol and algorithms define how to use these IP subflows for a traffic, in a joint-optimal manner. In some embodiments, LTE EPC need not control this mapping, if it enables the use of multiple IP addresses over different data paths, in dual connectivity.

“Link Model for Multi-Prefix EPS Bearer” (WO 2013/083189) issued a mechanism to support IPv6 multi-homing by allowing to use multiple IPv6 prefixes over a single PDN connection. According to this application, ordinary EPS bearer services are supported via a P-GW and possible additional Local IP Breakout services from the S-GW and the eNB by using co-located L-GW i.e. having multiple IP points of attachments each using different IPv6 prefix on the single data path (UE-eNB-S-GW-P-GW). According to this invention, different bearers are used for the different IP Prefixes only at the Radio interface, but not in the core network.

MPTCP is specified by IETF in RFC6824 as TCP extensions for Multipath Operation with Multiple Addresses, in January 2013. The architecture, connection management, subflow handling and coupled congestion control (RFC6356) are defined in IP layer and above. MPTCP stack, as shown in RFC6824 and replicated in FIG. 1, is different from the conventional TCP/IP stack.

The benefits of MPTCP are achievable best if different routing paths between the source and destination can be provided. For end-to-end paths which include wireless access (last mile) between the client and the server, the radio access network is typically the critical section along the path in terms of bandwidth, delay and link robustness. If multi-access radio connections cannot be provided for a wireless device, when MPTCP is used, the multipath benefits are limited to the fixed network transport. The use of wireless access networks is out-of scope of the IETF descriptions.

An Access Point Name (APN) is a name of a gateway between a mobile network and another computer network, such as the Internet. APN may consist of network identifier and operator identifier. Network identifier defines to which external network the access network is connected to, via the PDN gateway (P-GW) of an operator. Operator identifier defines in which network the gateway is located (for example it may be the PLMN of an operator or it may be an Internet service provider).

3GPP TS 24.301 and 24.008 define the procedures and TFT/TAD filters which the proposed invention with its proposed additions is based on.

3GPP TS 23.401, section 5.4.5 and FIG. 5.4.5.-1 (herein replicated as FIG. 2), explains the UE requested bearer resource modification procedure for an E-UTRAN. The procedure allows the UE to request for a modification of bearer resources (e.g. allocation or release of resources) for one traffic flow aggregate with a specific QoS demand. If accepted by the network, the request invokes the Dedicated Bearer Activation Procedure. The procedure is used by the UE when the UE already has a PDN connection with the PDN GW. Modification and deletion of a bearer are possible by the procedure, too, but not considered in the context of the present application.

In this procedure the UE signals a Traffic Aggregate Description (TAD) which is a partial TFT, together with a Procedure Transaction Identifier (PTI). The TAD is released by the UE after it has received a TFT related to the current PTI from the network.

Basically, the steps shown in FIG. 2 are as follows (for further details, see 3GPP TS 23.401):
1. In order to add a bearer, the UE sends a Request Bearer Resource Modification (LBI, PTI, QoS, TAD, Protocol Configuration Options) message to the MME. The TAD indicates one requested operation (add, modify, or delete packet filters). If traffic flows are added, the TAD includes the packet filter(s) (consisting of the packet filter information including packet filter precedence, but without a packet filter identifier) to be added. The UE also sends the QCI requested and GBR, if applicable, for the added traffic flows.
2. The MME sends the Bearer Resource Command (IMSI, LBI, PTI, QoS, TAD, Protocol Configuration Options) message to the selected Serving GW. The MME validates the request using the Linked Bearer Id. The same Serving GW address is used by the MME as for the EPS Bearer identified by the Linked Bearer Id received in the Request Bearer Resource Modification message.
3. The Serving GW sends the Bearer Resource Command (IMSI, LBI, PTI, QoS, TAD, Protocol Configuration Options) message to the PDN GW. The Serving GW sends the message to the same PDN GW as for the EPS Bearer identified by the Linked Bearer Id.
4. The PDN GW may either apply a locally configured QoS policy, or it may interact with the PCRF to trigger the appropriate PCC decision, which may take into account subscription information.
5. If the request to add a bearer is accepted, the Dedicated Bearer Activation Procedure (according to clause 5.4.1 of 3GPP TS 23.401) is invoked. The PTI allocated by the UE is used as a parameter in the invoked Dedicated Bearer Activation Procedure. FIG. 2 shows also options for modifying and deleting a bearer.
6. If the PDN GW interacted with the PCRF in step 4, the PDN GW indicates to the PCRF whether the PCC decision could be enforced or not.

3GPP TS 24.301, section 9.9.4.15, and TS 24.008, section 10.5.6.12, define the TFT with its filters. FIGS. 3 to 5 show some format of TFTs taken from 3GPP TS 24.008.

FIG. 6 shows Table 8.3.10.1: BEARER RESOURCE MODIFICATION REQUEST message content of 3GPP TS 23.401.

### SUMMARY OF THE INVENTION

It is an object of the present invention to improve the prior art.

According to a first aspect of the invention, there is provided an apparatus, comprising monitoring means adapted to monitor if a second data path is established for a flow, wherein a first internet protocol address is configured for the flow via a first data path between the apparatus and a packet data network; assigning means adapted to assign, if the second data path is established, a second internet protocol address different from the first internet protocol address for the flow via the second data path, wherein at least a part of the first data path belongs to a radio access technology; at least a part of the second data path belongs to the radio access technology; and the part of the first data path is different from the part of the second data path.

The monitoring means may be adapted to determine that the second data path is established if a bearer resource modification command for the second data path is issued.

The apparatus may further comprise supervising means adapted to supervise if a network to which the apparatus is connected, enables establishing of the second data path; and establishing means adapted to establish the second data path by issuing the bearer resource modification command if the establishing is enabled.

The apparatus may further comprise address including means adapted to include the second internet protocol address into the bearer resource modification command.

The apparatus may further comprise multipath checking means adapted to check if the flow is a multipath flow comprising the first data path and the second data path, wherein in the multipath flow data of the flow are distributed on the first data path and the second data path; relevance including means adapted to include a relevance indicator into the bearer resource modification command if the flow is the multipath flow.

The apparatus may further comprise multipath filter generating means adapted to generate a multipath filter comprising the second internet protocol address and the relevance indicator, wherein the multipath filter is related to the second data path; and filter including means adapted to include the multipath filter into the bearer resource modification command.

The apparatus may further comprise single-path filter generating means adapted to generate a single-path filter comprising the first internet protocol address and not comprising the relevance indicator, wherein the single-path filter is related to the second data path; wherein
the filter including means may be adapted to include the single-path filter into the bearer resource modification command.

The relevance including means may be adapted to include the relevance indicator by setting a length of the second internet protocol address to maximum.

Each of the first internet protocol address and the second internet protocol address may be an address of internet protocol version 6, and the apparatus may comprise address generating means adapted to use a prefix of the first internet protocol address based on prefix information received from the packet data network, to generate the prefix of the second internet protocol address to be the same as the prefix of the first internet protocol address, to generate an interface identifier of the first internet protocol address based on a first interface to the first data path, and to generate the interface identifier of the second internet protocol address based on a second interface to the second data path such that the interface identifier of the first internet protocol address is different from the interface identifier of the second internet protocol address.

According to a second aspect of the invention, there is provided an apparatus, comprising monitoring circuitry configured to monitor if a second data path is established for a flow, wherein a first internet protocol address is configured for the flow via a first data path between the apparatus and a packet data network; assigning circuitry configured to assign, if the second data path is established, a second internet protocol address different from the first internet protocol address for the flow via the second data path, wherein at least a part of the first data path belongs to a radio access technology; at least a part of the second data path belongs to the radio access technology; and the part of the first data path is different from the part of the second data path.

The monitoring circuitry may be configured to determine that the second data path is established if a bearer resource modification command for the second data path is issued.

The apparatus may further comprise supervising circuitry configured to supervise if a network to which the apparatus is connected, enables establishing of the second data path; and establishing circuitry configured to establish the second data path by issuing the bearer resource modification command if the establishing is enabled.

The apparatus may further comprise address including circuitry configured to include the second internet protocol address into the bearer resource modification command.

The apparatus may further comprise multipath checking circuitry configured to check if the flow is a multipath flow comprising the first data path and the second data path, wherein in the multipath flow data of the flow are distributed on the first data path and the second data path; relevance including circuitry configured to include a relevance indicator into the bearer resource modification command if the flow is the multipath flow.

The apparatus may further comprise multipath filter generating circuitry configured to generate a multipath filter comprising the second internet protocol address and the relevance indicator, wherein the multipath filter is related to the second data path; and filter including circuitry configured to include the multipath filter into the bearer resource modification command.

The apparatus may further comprise single-path filter generating circuitry configured to generate a single-path filter comprising the first internet protocol address and not comprising the relevance indicator, wherein the single-path filter is related to the second data path; wherein the filter including circuitry may be configured to include the single-path filter into the bearer resource modification command.

The relevance including circuitry may be configured to include the relevance indicator by setting a length of the second internet protocol address to maximum.

Each of the first internet protocol address and the second internet protocol address may be an address of internet protocol version 6, and the apparatus may comprise address generating circuitry configured to use a prefix of the first internet protocol address based on prefix information received from the packet data network, to generate the prefix of the second internet protocol address to be the same as the prefix of the first internet protocol address, to generate an interface identifier of the first internet protocol address based on a first interface to the first data path, and to generate the interface identifier of the second internet protocol address based on a second interface to the second data path such that the interface identifier of the first internet protocol address is different from the interface identifier of the second internet protocol address.

According to a third aspect of the invention, there is provided an apparatus, comprising monitoring means adapted to monitor if a received bearer resource modification command related to a flow to a terminal comprises a second internet protocol address, wherein the flow is established via a first data path using a first internet protocol address to address the terminal, the bearer resource modification command requests to establish a second data path for the flow to the terminal, the second data path is different from the first data path, and the second internet protocol address is different from the first internet protocol address; assigning means adapted to assign, if the bearer resource modification command comprises the second internet protocol address, the second internet protocol address to the second data path for the flow to the terminal.

The apparatus may further comprise checking means adapted to check if the bearer resource modification command comprises a relevance indicator; distributing means adapted to distribute, if the bearer resource modification command comprises the relevance indicator, data of the flow to the first data path and to the second data path according to a multipath protocol.

The apparatus may further comprise multipath checking means adapted to check if a second flow to the terminal belongs to the multipath protocol; evaluating means adapted to evaluate if a multipath filter comprises the relevance indicator, wherein the multipath filter is comprised in the bearer resource modification command and is related to the second data path; wherein the distributing means may be adapted to distribute data of the second flow on the first data path and the second data path according to the multipath filter if the second flow belongs to the multipath protocol and the multipath filter comprises the relevance indicator; and the apparatus may comprise addressing means adapted to address the terminal, if data are distributed on the second path, by the internet protocol address comprised in the multipath filter.

The evaluating means may be further adapted to evaluate if a further filter different from the multi-path filter comprises the relevance indicator, wherein the further filter is comprised in the bearer resource modification command and is related to the second data path; the distributing means may be adapted to distribute the data of the second flow to the second data path and not to the first data path according to the further filter if at least one of the following conditions is fulfilled: the second flow does not belong to the multipath protocol and the further filter does not comprise the relevance indicator; and the addressing means may be adapted to address the terminal, on the second data path, by the internet protocol address comprised in the further filter.

The checking means may be adapted to determine that the bearer resource modification command comprises the relevance indicator if a length of the second internet protocol address is set at maximum.

Each of the first internet protocol address and the second internet protocol address may be an address of internet protocol version 6, the first internet protocol address has a first interface identifier different from a second interface identifier of the second internet protocol address, and the apparatus may comprise prefix providing means adapted to provide one prefix to the terminal to be used for both the first internet protocol and the second internet protocol address.

The distributing means may be adapted to distribute the data of the flow based on the first interface identifier and the second interface identifier if the bearer resource modification command comprises the relevance indicator.

The distributing means may be adapted to distribute the data of the second flow to the second data path and not to the first data path based on the prefix and disregarding the first interface identifier and the second interface identifier if the further filter does not comprise the relevance indicator.

According to a fourth aspect of the invention, there is provided an apparatus, comprising monitoring circuitry configured to monitor if a received bearer resource modification command related to a flow to a terminal comprises a second internet protocol address, wherein the flow is established via a first data path using a first internet protocol address to address the terminal, the bearer resource modification command requests to establish a second data path for the flow to the terminal, the second data path is different from the first data path, and the second internet protocol address is different from the first internet protocol address; assigning circuitry configured to assign, if the bearer resource modification command comprises the second internet protocol address, the second internet protocol address to the second data path for the flow to the terminal.

The apparatus may further comprise checking circuitry configured to check if the bearer resource modification command comprises a relevance indicator; distributing circuitry configured to distribute, if the bearer resource modification command comprises the relevance indicator, data of the flow to the first data path and to the second data path according to a multipath protocol.

The apparatus may further comprise multipath checking circuitry configured to check if a second flow to the terminal belongs to the multipath protocol; evaluating circuitry configured to evaluate if a multipath filter comprises the relevance indicator, wherein the multipath filter is comprised in the bearer resource modification command and is related to the second data path; wherein the distributing circuitry may be configured to distribute data of the second flow on the first data path and the second data path according to the multipath filter if the second flow belongs to the multipath protocol and the multipath filter comprises the relevance indicator; and the apparatus may comprise addressing circuitry configured to address the terminal, if data are distributed on the second path, by the internet protocol address comprised in the multipath filter.

The evaluating circuitry may be further configured to evaluate if a further filter different from the multi-path filter comprises the relevance indicator, wherein the further filter is comprised in the bearer resource modification command and is related to the second data path; the distributing circuitry may be configured to distribute the data of the second flow to the second data path and not to the first data path according to the further filter if at least one of the following conditions is fulfilled: the second flow does not belong to the multipath protocol and the further filter does not comprise the relevance indicator; and the addressing circuitry may be configured to address the terminal, on the second data path, by the internet protocol address comprised in the further filter.

The checking circuitry may be configured to determine that the bearer resource modification command comprises the relevance indicator if a length of the second internet protocol address is set at maximum.

Each of the first internet protocol address and the second internet protocol address may be an address of internet protocol version 6, the first internet protocol address has a first interface identifier different from a second interface identifier of the second internet protocol address, and the apparatus may comprise prefix providing circuitry configured to provide one prefix to the terminal to be used for both the first internet protocol and the second internet protocol address.

The distributing circuitry may be configured to distribute the data of the flow based on the first interface identifier and the second interface identifier if the bearer resource modification command comprises the relevance indicator.

The distributing circuitry may be configured to distribute the data of the second flow to the second data path and not to the first data path based on the prefix and disregarding the first interface identifier and the second interface identifier if the further filter does not comprise the relevance indicator.

According to a fifth aspect of the invention, there is provided a method, comprising monitoring if a second data path is established for a flow, wherein a first internet protocol address is configured for the flow via a first data path between an apparatus performing the method and a packet data network; assigning, if the second data path is established, a second internet protocol address different from the first internet protocol address for the flow via the second data path, wherein at least a part of the first data path belongs to a radio access technology; at least a part of the second data path belongs to the radio access technology; and the part of the first data path is different from the part of the second data path.

The monitoring may comprise determining that the second data path is established if a bearer resource modification command for the second data path is issued.

The method may further comprise supervising if a network to which the apparatus is connected, enables establishing of the second data path; and establishing the second data path by issuing the bearer resource modification command if the establishing is enabled.

The method may further comprise including the second internet protocol address into the bearer resource modification command.

The method may further comprise checking if the flow is a multipath flow comprising the first data path and the second data path, wherein in the multipath flow data of the flow are distributed on the first data path and the second data path; including a relevance indicator into the bearer resource modification command if the flow is the multipath flow.

The method may further comprise generating a multipath filter comprising the second internet protocol address and the relevance indicator, wherein the multipath filter is related to the second data path; and including the multipath filter into the bearer resource modification command.

The method may further comprise generating a single-path filter comprising the first internet protocol address and not comprising the relevance indicator, wherein the single-path filter is related to the second data path; and including the single-path filter into the bearer resource modification command.

The relevance indicator may be included by setting a length of the second internet protocol address to maximum.

Each of the first internet protocol address and the second internet protocol address may be an address of internet protocol version 6, and the method may comprise using a prefix of the first internet protocol address based on prefix information received from the packet data network, generating the prefix of the second internet protocol address to be the same as the prefix of the first internet protocol address, generating an interface identifier of the first internet protocol address based on a first interface to the first data path, and generating the interface identifier of the second internet protocol address based on a second interface to the second data path such that the interface identifier of the first internet protocol address is different from the interface identifier of the second internet protocol address.

According to a sixth aspect of the invention, there is provided a method, comprising monitoring if a received bearer resource modification command related to a flow to a terminal comprises a second internet protocol address, wherein the flow is established via a first data path using a first internet protocol address to address the terminal, the bearer resource modification command requests to establish a second data path for the flow to the terminal, the second data path is different from the first data path, and the second internet protocol address is different from the first internet protocol address; assigning, if the bearer resource modification command comprises the second internet protocol address, the second internet protocol address to the second data path for the flow to the terminal.

The method may further comprise checking if the bearer resource modification command comprises a relevance indicator; distributing, if the bearer resource modification command comprises the relevance indicator, data of the flow to the first data path and to the second data path according to a multipath protocol.

The method may further comprise checking if a second flow to the terminal belongs to the multipath protocol; evaluating if a multipath filter comprises the relevance indicator, wherein the multipath filter is comprised in the bearer resource modification command and is related to the second data path; wherein the distributing may be adapted to distribute data of the second flow on the first data path and the second data path according to the multipath filter if the second flow belongs to the multipath protocol and the multipath filter comprises the relevance indicator; and the method may comprise addressing the terminal, if data are distributed on the second path, by the internet protocol address comprised in the multipath filter.

The evaluating may be adapted to evaluate if a further filter different from the multi-path filter comprises the relevance indicator, wherein the further filter is comprised in the bearer resource modification command and is related to the second data path; the distributing may be adapted to distribute the data of the second flow to the second data path and not to the first data path according to the further filter if at least one of the following conditions is fulfilled: the second flow does not belong to the multipath protocol and the further filter does not comprise the relevance indicator; and the addressing may be adapted to address the terminal, on the second data path, by the internet protocol address comprised in the further filter.

The checking may be adapted to determine that the bearer resource modification command comprises the relevance indicator if a length of the second internet protocol address is set at maximum.

Each of the first internet protocol address and the second internet protocol address may be an address of internet protocol version 6, the first internet protocol address has a first interface identifier different from a second interface identifier of the second internet protocol address, and the method may comprise providing one prefix to the terminal to be used for both the first internet protocol and the second internet protocol address.

The distributing may be adapted to distribute the data of the flow based on the first interface identifier and the second interface identifier if the bearer resource modification command comprises the relevance indicator.

The distributing may be adapted to distribute the data of the second flow to the second data path and not to the first data path based on the prefix and disregarding the first interface identifier and the second interface identifier if the further filter does not comprise the relevance indicator.

Each of the methods of the fifth and sixth aspects may be a method for a multipath TCP connection.

According to a seventh aspect of the invention, there is provided a computer program product comprising a set of instructions which, when executed on an apparatus, is configured to cause the apparatus to carry out the method according to any one of the fifth and sixth aspects. The computer program product may be embodied as a computer-readable medium or directly loadable into a computer.

According to some embodiments of the invention, at least one of the following advantages may be achieved:
An own IID is assigned to the dedicated bearer;
P-GW is made aware of the IID to be used for traffic separation;
multi-path traffic and single-path traffic may use the same dedicated bearer;
the solution is backwards compatible.

From MPTCP point of view, having two IP addresses for the 3GPP access over two different cell layers, both MPTCP paths would be in full control of the operator, but yet maintaining the multipath benefits on the IP layer, serving the common TCP entity and layers above the TCP ports.

MPTCP run in this way allows throughput increase, better link robustness, (automatic) balancing of load over the two paths and in addition, a joint congestion (TCP) algorithm.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows a MPTCP stack according to RFC6824;

FIG. 2 shows a message flow according to 3GPP TS 23.401, section 5.4.5;

FIG. 3 shows a Traffic flow template information element according to FIG. 10.5.144 of 3GPP TS 24.008: Traffic flow template information element;

FIG. 4 shows a Packet filter list when the TFT operation is “delete packet filters from existing TFT” (z=N+3), according to FIG. 10.5.144a of 3GPP TS 24.008;

FIG. 5 shows a Packet filter list when the TFT operation is “create new TFT”, or “add packet filters to existing TFT” or “replace packet filters in existing TFT”, according to FIG. 10.5.144b of 3GPP TS 24.008;

FIG. 6 shows Table 8.3.10.1: BEARER RESOURCE MODIFICATION REQUEST message content of 3GPP TS 23.401;

FIG. 7 shows an apparatus according to an embodiment of the invention;

FIG. 8 shows a method according to an embodiment of the invention;

FIG. 9 shows an apparatus according to an embodiment of the invention;

FIG. 10 shows a method according to an embodiment of the invention; and

FIG. 11 shows an apparatus according to an embodiment of the invention.

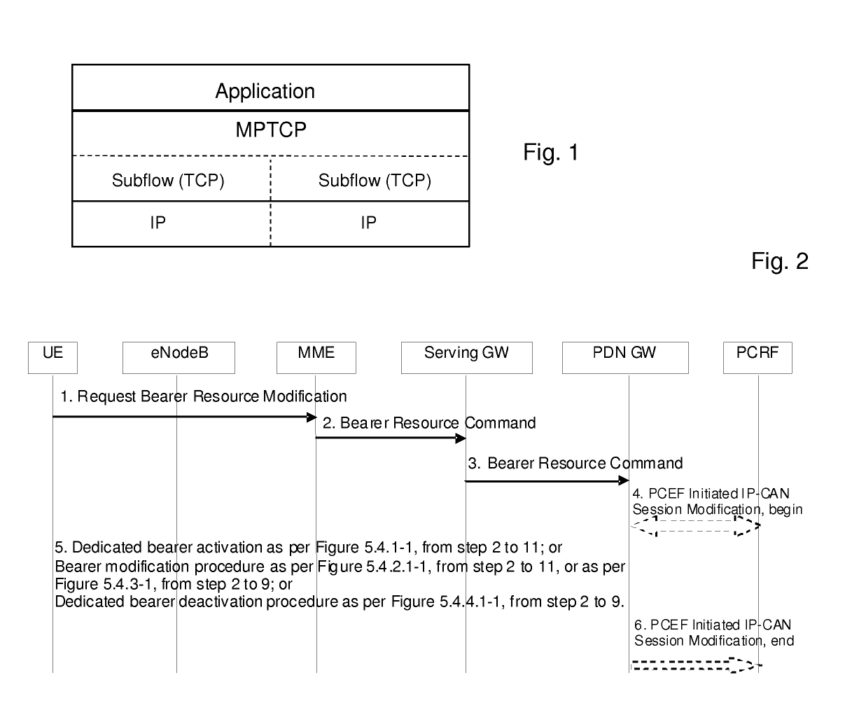

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

PCT/EP2014/061325 states: “Again here the 3GPP specifications should enable UE to configure the Interface Identifier portion of the IPv6 address freely per each EPS bearer and the P-GW should be made aware to route downlink data traffic according to the source IPv6 address the UE is using for each EPS bearer.” But details how this should be achieved are not given.

Assuming a PDN connection with one default bearer (Pre1+IID1) and one dedicated bearer the problems to solve are:
1) The dedicated bearer must get assigned an own IID2.
2) The PGW needs to be made aware that the IID2 should be used for traffic separation. (The TFT filter information today contains the IID part but it is not used for filtering.)
3) A schema needs to be introduced that works with and without MPTCP and the solution needs to be backward compatible (with and without evaluating the IID). So it is assumed that a bearer may carry either an MPTCP flow (or several MPTCP flows), only non-MPTCP flows or both.

Some embodiments of the invention apply to devices/UE capable for dual connectivity. The availability of small cells and dual connectivity in the location the UE is roaming may be a trigger for the UE to establish a dedicated bearer if it so far supports only the default bearer.

According to some embodiments of the invention, a MPTCP capable UE will assign an IID2 when establishing a dedicated bearer.

To establish or modify a dedicated bearer for an MPTCP flow the UE can use the UE-core network related procedure (NAS) in 23.401 [1], section 5.4.5 “UE requested bearer resource modification”. In both cases (i.e. establishing and modifying the dedicated bearer) the newly created IID2 may be transferred. E.g., IID2 may be transferred in the TAD/TFT filters. Alternatively or in addition, IID2 may be transferred in a new parameter, or in an enhancement of e.g. the Protocol Configuration Options (PCO). In addition, a relevance parameter, hereinafter sometimes named “IID relevant” parameter indicating if IID2 is relevant for MPTCP may be transferred in a new parameter, or in an enhancement of e.g. the Protocol Configuration Options (PCO). In this case, messages 1. to 3. of FIG. 2 are enhanced over their conventional format.

If the same bearer carries both MPTCP and non-MPTCP flows (also named single-path flows), filters for each flow are parallel set up for the bearer. The filters for the non-MPTCP flows may be based on IPv6 prefix as per current specifications, i.e. with no “IID relevant” marking, and the filters for the MPTCP flows may be based on the use of the whole IPv6 address, i.e. both the prefix and IID, with “IID relevant” marking. In some embodiments of the invention, the presence of the “IID relevant marking” triggers the network/P-GW to heed also the IID part of the IPv6 filter, whereas the absence of the “IID relevant marking” causes the network/P-GW to operate on the filter ignoring the IID part.

In some embodiments of the invention, a higher precedence/priority is allocated to a filter with IID marking than to filters with a prefix only usage. This way the packets matching the IID can be routed to the correct bearer.

In the same messages, a new traffic filter or filter modification may be performed with the TAD/TFT parameter, as according to 3GPP TS 23.401:

“The TAD indicates one requested operation (add, modify, or delete packet filters). If traffic flows are added, the TAD includes the packet filter(s) (consisting of the packet filter information including packet filter precedence, but without a packet filter identifier) to be added. If the UE wants to link the new packet filter(s) to an existing packet filter to enable the usage of existing bearer resources for the new packet filter(s), the UE shall provide an existing packet filter identifier together with the new packet filter(s).”

According to some embodiments of the invention, when adding or modifying a dedicated bearer, it may be combined with a change of the QoS parameters for an existing bearer to be better suited for MPTCP. E.g. MPTCP works best if both paths/bearers have a comparable bandwidth and delay characteristic.

According to some embodiments of the invention, the new/modified filter contains IID2 for the UE source IP address parameter (in case of modification, IID1 may be overwritten by IID2). In the P-GW, those filters may get a label to be the only ones that should treat the IID as filter criteria in order to solve problem (2) hereinabove.

The existence of the new parameter “IID” or only a marker “IID relevant” for certain filters in the messages 1. to 3. of FIG. 2, will trigger the PGW to take also the IID as a filter criteria when allocating traffic to that bearer.

Thus, the problems 1) and 2) are solved by some embodiments of the invention.

Internally, the UE also allocates the Prefix1+IID2 as source address to the dedicated bearer so that two different IP addresses are available for the TCP/IP stacks of MPTCP.

In order to solve problem 3, according to some embodiments of the invention, a schema is introduced that works for flows with and without MPTCP (multipath flows and single-path flows). Preferably, the schema is backward compatible (i.e. covers the cases of evaluating and not-evaluating the IID). An example is a case, where a bearer should carry in addition to TCP/MPTCP traffic some single-path traffic, e.g. UDP traffic. The UDP traffic is not distributed over several bearers but transported on the dedicated bearer only.

According to some embodiments of the invention, if MPTCP will not be used with the dedicated bearer, the same IID1 as for the default bearer will be used as usual. Consequently, according to some of these embodiments, there are at least two filters in the TADs/TFTs:
1. For non-MPTCP traffic, TFT filter(s)1 as usual to identify some flows/services etc. It has flow parameters in addition to the UE source IP address with IID1 (IID1 may be ignored in the P-GW), otherwise no traffic would go through the default bearer.
2. Second TFT filter2 for MPTCP: it contains at least UE source address with IID2 (in the destination address part of the DL traffic filter), and in addition the port number for TCP may be set. That filter has the label for IID treatment (“IID relevant”).

According to some embodiments, the priority of the filters may be as follows:
1.) Filter2 for MPTCP
2.) Filter(s)1 for no MPTCP

Consequently, in these embodiments of the invention, the concept of running old and new filters in parallel means that the dedicated bearer receives packets with two IP addresses:
Prefix1+IID1 (IID1 is also used in the default bearer) for non-MPTCP traffic; and
Prefix1+IID2 created for MPTCP.

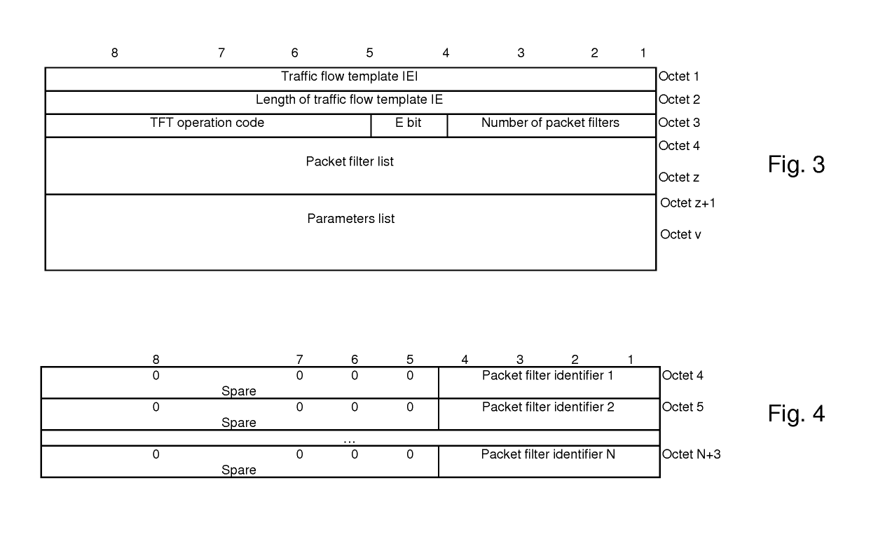

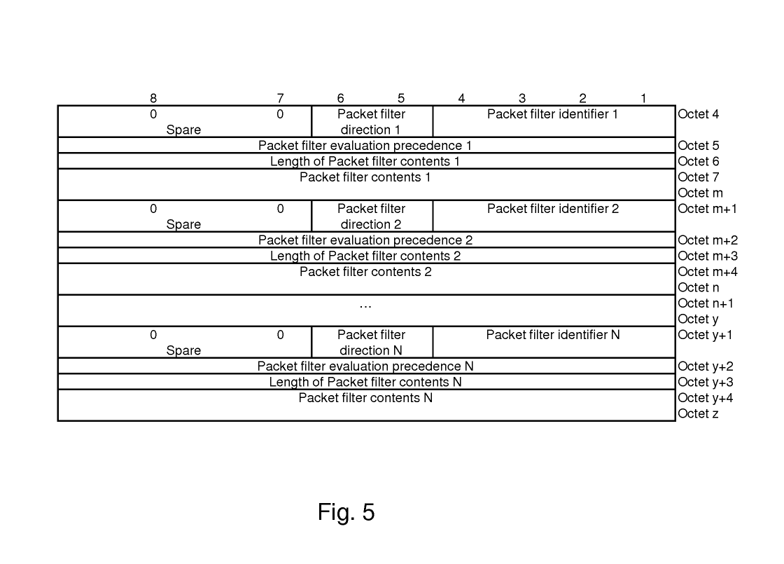

As obvious, the suggested “IID relevant” indication may in practice be transferred in many different ways. For example, it may be transferred in one of the spare bits contained in the packet filter list (which is part of the TFT definition) for each filter (see FIGS. 3 to 5).

The IPv6 address is defined in the TFT (as per TS 24.008) with “a sixteen octet IPv6 address field and one octet prefix length field”. So, according to some embodiments of the invention, a filter is indicated to be “IID relevant” by setting the prefix length to the maximum, indicating that all bits of the address are relevant for the filter.

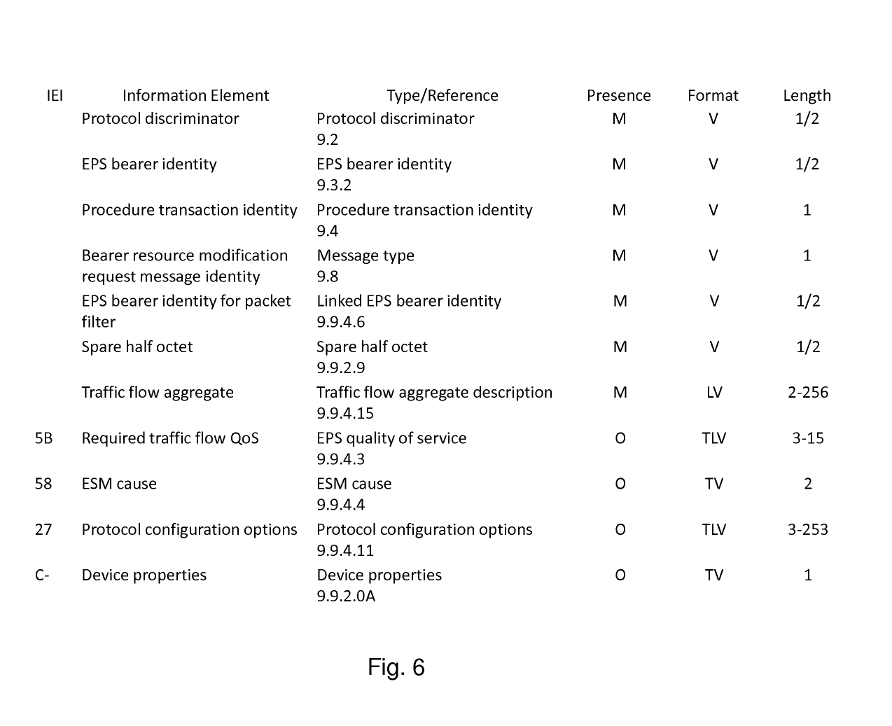

The Bearer Resource Modification request message, as shown in FIG. 6, supports a container mechanism, the Protocol Configuration Options (PCO) information element. Consequently, in some embodiments of the invention, the “IID relevant” indication is transported in a PCO container. Therein, other new parameters (even filter definitions, if needed) may be transported, too.

According to some embodiments of the invention, the indication that a filter is “IID relevant” is transferred in a newly defined information element in the used message. The information element may contain e.g. filter IDs (as per the TFT definition) and the related “IID relevant” indications, and if appropriate/needed, any other new parameters (even filter definitions).

According to some embodiments of the invention, traffic for MPTCP is separated (distributed over bearers such as default bearer and dedicated bearer) with minimal changes to the current 3GPP procedures. In some embodiments of the invention, only one new parameter (the interface ID for the dedicated bearer) is transferred between UE and P-GW. In some embodiments of the invention, the filters that contain the “dedicated” IID are marked to inform the PGW that the IID will be taken into account for traffic filtering (“IID relevance”).

The provision of multi-access/path by the same 3GPP technology i.e. using macro network and using a separate small cell layer, networking is in much better control of the 3GPP EPC, compared to multi-access by 3GPP and non-3GPP (WLAN) accesses. The control of radio resources can be kept in the MeNB, which configures master cell group and small cell group for the UE.

From MPTCP point of view, having two IP addresses over the 3GPP access over two different cell layers, both MPTCP paths are in full control of the operator, but yet maintaining the multipath benefits on the IP layer, serving the common TCP entity and layers above TCP.

In case MPTCP is run this way, it allows throughput increase, better link robustness, automatic balancing of load over the two paths and in addition, a joint congestion (tcp) algorithm. Even better, it may automatically tolerate drop of the other path, if e.g. small cell coverage would end, without any dramatic impact to the TCP (or application above it) other than throughput decrease.

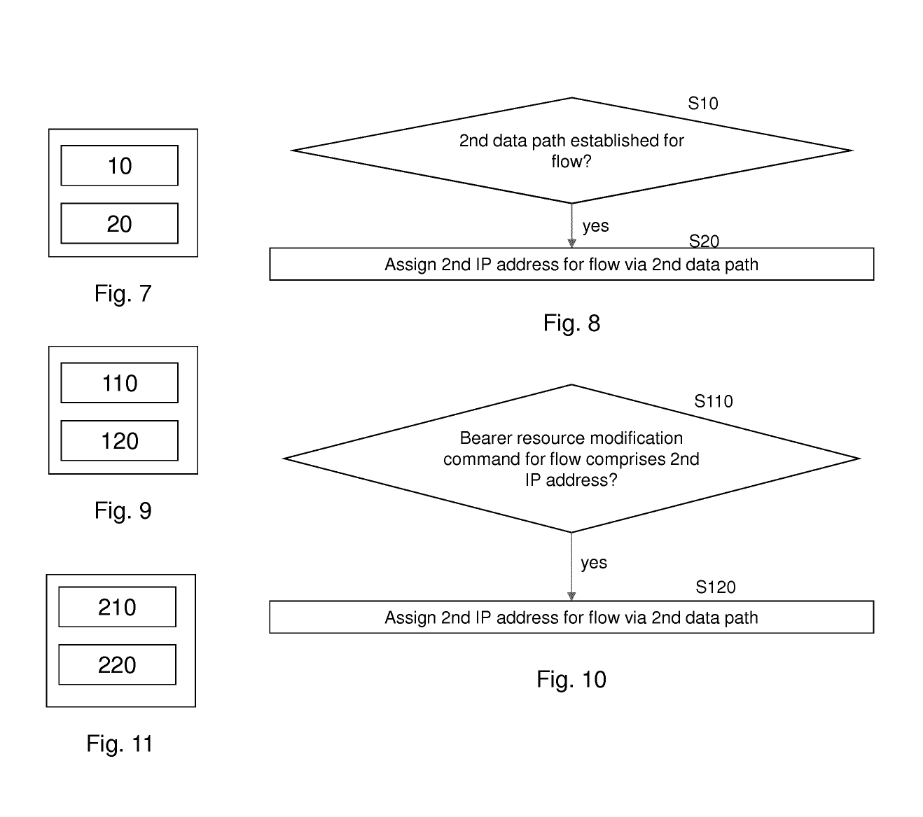

FIG. 7 shows an apparatus according to an embodiment of the invention. The apparatus may be a terminal such as a UE, or an element thereof. FIG. 8 shows a method according to an embodiment of the invention. The apparatus according to FIG. 7 may perform the method of FIG. 8 but is not limited to this method. The method of FIG. 8 may be performed by the apparatus of FIG. 7 but is not limited to being performed by this apparatus.

The apparatus comprises monitoring means 10, and assigning means 20.

The monitoring means 10 monitors if a second data path is established for a flow (S10). Therein, a first internet protocol address is configured for the flow via a first data path between the apparatus and a packet data network. At least a part of the first data path belongs to a radio access technology;

If the second data path is established (S10=“yes”), the assigning means 20 assigns a second internet protocol address different from the first internet protocol address for the flow via the second data path. At least a part of the second data path belongs to the radio access technology of the part of the first data path. The part of the first data path is different from the part of the second data path.

FIG. 9 shows an apparatus according to an embodiment of the invention. The apparatus may be a gateway such as a P-GW, or an element thereof. FIG. 10 shows a method according to an embodiment of the invention. The apparatus according to FIG. 9 may perform the method of FIG. 10 but is not limited to this method. The method of FIG. 10 may be performed by the apparatus of FIG. 9 but is not limited to being performed by this apparatus.

The apparatus comprises monitoring means 110 and assigning means 120.

The monitoring means 110 monitors if a received bearer resource modification command related to a flow to a terminal comprises a second internet protocol address (S110). Therein, the flow is established via a first data path using a first internet protocol address to address the terminal. The bearer resource modification command requests to establish a second data path for the flow to the terminal. The second data path is different from the first data path, and the second internet protocol address is different from the first internet protocol address.

If the bearer resource modification command comprises the second internet protocol address (S110=“yes”), the assigning means 120 assigns the second internet protocol address to the second data path for the flow to the terminal (S120).

FIG. 11 shows an apparatus according to an embodiment of the invention. The apparatus comprises at least one processor 210, at least one memory 220 including computer program code, and the at least one processor, with the at least one memory and the computer program code, being arranged to cause the apparatus to perform at least one of the methods according to FIGS. 8 and 10.

Embodiments of the invention may be employed in a 3GPP network such as EDGE, UMTS, LTE, and LTE-A. They may be employed also in other mobile networks enabling multiple data paths such as CDMA and Wi-Fi networks, etc.

A terminal may be any device capable to be connected to the radio access network, such as a UE, a laptop, a tablet, a smartphone, a communicator, a machine, a robot, a wearable etc.

Embodiments of the invention are described for two base stations and two data paths. However, the number of base stations per data path may be larger than two. For example, if the base stations are arranged in groups such as MCG and/or SCG, a data path may use some or all of the base stations of the respective base station group. The MCG may provide resources for multiple cells and multiple component carriers. The SCG may provide resources for multiple cells and multiple component carriers.

Also, the number of data paths is not limited to two. The UE may have more than two data paths with related IP addresses. Each of the data paths may comprise one or more base stations.

Embodiments of the invention are not limited to IPv6. They may use any suitable protocol. For example, IPv4 may be used if the P-GW assigns several IP addresses to the UE, and the MPTCP in the UE or the MPTCP in the server or combination thereof may select some of them for a multipath connection setup. This multipath setup is beneficial over LTE, if according to some embodiments of the invention, LTE network and LTE device are able to map the IP addresses to different data paths, the data paths being in dual connectivity. Also, embodiments of the invention may employ future versions of the internet protocol or a related protocol.

According to some embodiments of the invention, the terminal may be a LTE dual connectivity capable UE. According to some embodiments of the invention the EPC supports dual LTE radio interfaces/data paths associated to a single PDN connection. According to some embodiments of the invention, the EPC supports dual LTE interfaces/data paths associated to multiple PDN connections. According to some embodiments of the invention MPTCP protocol, MPTCP services, are provided over the Intra-LTE access dual connectivity.

Distribution of downlink traffic to different data paths may be based on MPTCP, as described. However, in some embodiments of the invention, only part of the MPTCP algorithms may be implemented, or other algorithms than MPTCP may be used to decide on the distribution of traffic to different data paths. For example, downlink traffic responding to uplink traffic may be routed via the data path on which the uplink traffic was routed. In some embodiments, the decision on the respective data path for downlink traffic may be communicated to the P-GW via signaling messages from a control entity.

Adding and modification of a dedicated bearer may be made using the Request Bearer Resource Modification as according to FIG. 2 and its enhancements as described herein. However, embodiments of the invention may use other commands and message flows resulting in adding/modifying a bearer and assigning it to a multipath flow. E.g., the command(s) may depend on the technology (such as a RAT) used to connect a terminal and P-GW.

Embodiments of the invention are described where multiple data paths are used for both uplink and downlink of a terminal. However, according to some embodiments of the invention, multiple data paths may be used for the uplink only, whereas all downlink traffic is routed via a single downlink data path to the terminal. Also in some embodiments of the invention, multiple data paths may be used for the downlink only, whereas all uplink traffic is routed via a single uplink path to the server. Also, in some embodiments of the invention, specific downlink traffic may be sent over multiple data paths, whereas other downlink traffic may be sent over a single data path. Also, in some embodiments of the invention, specific uplink traffic may be sent over multiple data paths, whereas other uplink traffic may be sent over a single data path. In each case, whether using multipath to one or both link directions, TCP Acknowledgements may be expected to the reverse direction, as TCP forms a bi-directional connection between the source and destination TCP ports.

One piece of information may be transmitted in one or plural messages from one entity to another entity. Each of these messages may comprise further (different) pieces of information.

Names of network elements, protocols, and methods are based on current standards. In other versions or other technologies, the names of these network elements and/or protocols and/or methods may be different, as long as they provide a corresponding functionality. The functionality may be integral to one or few of the network elements or it may be shared or distributed among the network elements, or their cloud.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software.

According to the above description, it should thus be apparent that exemplary embodiments of the present invention provide, for example a terminal such as a user equipment, or a component thereof, an apparatus embodying the same, a method for controlling and/or operating the same, and computer program(s) controlling and/or operating the same as well as mediums carrying such computer program(s) and forming computer program product(s). Furthermore, according to the above description, it should thus be apparent that exemplary embodiments of the present invention provide, for example a gateway such as a P-GW, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1. Apparatus, comprising
monitoring means adapted to monitor if a second data path is established for a flow, wherein a first internet protocol address is configured for the flow via a first data path between the apparatus and a packet data network;
assigning means adapted to assign, if the second data path is established, a second internet protocol address different from the first internet protocol address for the flow via the second data path, wherein
at least a part of the first data path belongs to a radio access technology;
at least a part of the second data path belongs to the radio access technology; and
the part of the first data path is different from the part of the second data path.

2. The apparatus according to claim 1, wherein
the monitoring means is adapted to determine that the second data path is established if a bearer resource modification command for the second data path is issued.

3. The apparatus according to claim 2, further comprising
supervising means adapted to supervise if a network to which the apparatus is connected, enables establishing of the second data path; and
establishing means adapted to establish the second data path by issuing the bearer resource modification command if the establishing is enabled.

4. The apparatus according to claim 2, further comprising
address including means adapted to include the second internet protocol address into the bearer resource modification command.

5. The apparatus according to claim 4, further comprising
multipath checking means adapted to check if the flow is a multipath flow comprising the first data path and the second data path, wherein in the multipath flow data of the flow are distributed on the first data path and the second data path;
relevance including means adapted to include a relevance indicator into the bearer resource modification command if the flow is the multipath flow.

6. The apparatus according to claim 5, further comprising
multipath filter generating means adapted to generate a multipath filter comprising the second internet protocol address and the relevance indicator, wherein the multipath filter is related to the second data path; and
filter including means adapted to include the multipath filter into the bearer resource modification command.

7. The apparatus according to claim 6, further comprising
single-path filter generating means adapted to generate a single-path filter comprising the first internet protocol address and not comprising the relevance indicator, wherein the single-path filter is related to the second data path; wherein
the filter including means is adapted to include the single-path filter into the bearer resource modification command.

8. The apparatus according to claim 5, wherein the relevance including means is adapted to include the relevance indicator by setting a length of the second internet protocol address to maximum.

9. The apparatus according to claim 1, wherein each of the first internet protocol address and the second internet protocol address is an address of internet protocol version 6, and the apparatus comprises
address generating means adapted to use a prefix of the first internet protocol address based on prefix information received from the packet data network, to generate the prefix of the second internet protocol address to be the same as the prefix of the first internet protocol address, to generate an interface identifier of the first internet protocol address based on a first interface to the first data path, and to generate the interface identifier of the second internet protocol address based on a second interface to the second data path such that the interface identifier of the first internet protocol address is different from the interface identifier of the second internet protocol address.

10. Apparatus, comprising
monitoring means adapted to monitor if a received bearer resource modification command related to a flow to a terminal comprises a second internet protocol address, wherein the flow is established via a first data path using a first internet protocol address to address the terminal, the bearer resource modification command requests to establish a second data path for the flow to the terminal, the second data path is different from the first data path, and the second internet protocol address is different from the first internet protocol address;
assigning means adapted to assign, if the bearer resource modification command comprises the second internet protocol address, the second internet protocol address to the second data path for the flow to the terminal.

11. The apparatus according to claim 10, further comprising
checking means adapted to check if the bearer resource modification command comprises a relevance indicator;
distributing means adapted to distribute, if the bearer resource modification command comprises the relevance indicator, data of the flow to the first data path and to the second data path according to a multipath protocol.

12. The apparatus according to claim 11, further comprising
multipath checking means adapted to check if a second flow to the terminal belongs to the multipath protocol;
evaluating means adapted to evaluate if a multipath filter comprises the relevance indicator, wherein the multipath filter is comprised in the bearer resource modification command and is related to the second data path; wherein
the distributing means is adapted to distribute data of the second flow on the first data path and the second data path according to the multipath filter if the second flow belongs to the multipath protocol and the multipath filter comprises the relevance indicator; and the apparatus comprises
addressing means adapted to address the terminal, if data are distributed on the second path, by the internet protocol address comprised in the multipath filter.

13. The apparatus according to claim 12, wherein
the evaluating means is further adapted to evaluate if a further filter different from the multi-path filter comprises the relevance indicator, wherein the further filter is comprised in the bearer resource modification command and is related to the second data path;
the distributing means is adapted to distribute the data of the second flow to the second data path and not to the first data path according to the further filter if at least one of the following conditions is fulfilled: the second flow does not belong to the multipath protocol and the further filter does not comprise the relevance indicator; and
the addressing means is adapted to address the terminal, on the second data path, by the internet protocol address comprised in the further filter.

14. The apparatus according to claim 11, wherein the checking means is adapted to determine that the bearer resource modification command comprises the relevance indicator if a length of the second internet protocol address is set at maximum.

15. The apparatus according to claim 13, wherein each of the first internet protocol address and the second internet protocol address is an address of internet protocol version 6, the first internet protocol address has a first interface identifier different from a second interface identifier of the second internet protocol address, and the apparatus comprises
prefix providing means adapted to provide one prefix to the terminal to be used for both the first internet protocol and the second internet protocol address.

16. The apparatus according to claim 15, wherein
the distributing means is adapted to distribute the data of the flow based on the first interface identifier and the second interface identifier if the bearer resource modification command comprises the relevance indicator.

17. The apparatus according to claim 16, wherein
the distributing means is adapted to distribute the data of the second flow to the second data path and not to the first data path based on the prefix and disregarding the first interface identifier and the second interface identifier if the further filter does not comprise the relevance indicator.

18. Method, comprising
monitoring if a second data path is established for a flow, wherein a first internet protocol address is configured for the flow via a first data path between an apparatus performing the method and a packet data network;
assigning, if the second data path is established, a second internet protocol address different from the first internet protocol address for the flow via the second data path, wherein
at least a part of the first data path belongs to a radio access technology;
at least a part of the second data path belongs to the radio access technology; and
the part of the first data path is different from the part of the second data path.

19. The method according to claim 18, wherein
the monitoring comprises determining that the second data path is established if a bearer resource modification command for the second data path is issued.

20. The method according to claim 19, further comprising
supervising if a network to which the apparatus is connected, enables establishing of the second data path; and
establishing the second data path by issuing the bearer resource modification command if the establishing is enabled.

21. The method according to claim 19, further comprising
including the second internet protocol address into the bearer resource modification command.

22. The method according to claim 21, further comprising
checking if the flow is a multipath flow comprising the first data path and the second data path, wherein in the multipath flow data of the flow are distributed on the first data path and the second data path;
including a relevance indicator into the bearer resource modification command if the flow is the multipath flow.

23. The method according to claim 22, further comprising
generating a multipath filter comprising the second internet protocol address and the relevance indicator, wherein the multipath filter is related to the second data path; and
including the multipath filter into the bearer resource modification command.

24. The method according to claim 23, further comprising
generating a single-path filter comprising the first internet protocol address and not comprising the relevance indicator, wherein the single-path filter is related to the second data path; and
including the single-path filter into the bearer resource modification command.

25. The method according to claim 22, wherein the relevance indicator is included by setting a length of the second internet protocol address to maximum.

26. The method according to claim 18, wherein each of the first internet protocol address and the second internet protocol address is an address of internet protocol version 6, and the method comprises
using a prefix of the first internet protocol address based on prefix information received from the packet data network, generating the prefix of the second internet protocol address to be the same as the prefix of the first internet protocol address, generating an interface identifier of the first internet protocol address based on a first interface to the first data path, and generating the interface identifier of the second internet protocol address based on a second interface to the second data path such that the interface identifier of the first internet protocol address is different from the interface identifier of the second internet protocol address.

27. Method, comprising
monitoring if a received bearer resource modification command related to a flow to a terminal comprises a second internet protocol address, wherein the flow is established via a first data path using a first internet protocol address to address the terminal, the bearer resource modification command requests to establish a second data path for the flow to the terminal, the second data path is different from the first data path, and the second internet protocol address is different from the first internet protocol address;
assigning, if the bearer resource modification command comprises the second internet protocol address, the second internet protocol address to the second data path for the flow to the terminal.

28. The method according to claim 27, further comprising
checking if the bearer resource modification command comprises a relevance indicator;
distributing, if the bearer resource modification command comprises the relevance indicator, data of the flow to the first data path and to the second data path according to a multipath protocol.

29. The method according to claim 28, further comprising
checking if a second flow to the terminal belongs to the multipath protocol;
evaluating if a multipath filter comprises the relevance indicator, wherein the multipath filter is comprised in the bearer resource modification command and is related to the second data path; wherein
the distributing is adapted to distribute data of the second flow on the first data path and the second data path according to the multipath filter if the second flow belongs to the multipath protocol and the multipath filter comprises the relevance indicator; and the method comprises
addressing the terminal, if data are distributed on the second path, by the internet protocol address comprised in the multipath filter.

30. The method according to claim 29, wherein
the evaluating is adapted to evaluate if a further filter different from the multi-path filter comprises the relevance indicator, wherein the further filter is comprised in the bearer resource modification command and is related to the second data path;
the distributing is adapted to distribute the data of the second flow to the second data path and not to the first data path according to the further filter if at least one of the following conditions is fulfilled: the second flow does not belong to the multipath protocol and the further filter does not comprise the relevance indicator; and
the addressing is adapted to address the terminal, on the second data path, by the internet protocol address comprised in the further filter.

31. The method according to claim 28, wherein the checking is adapted to determine that the bearer resource modification command comprises the relevance indicator if a length of the second internet protocol address is set at maximum.

32. The method according to claim 30, wherein each of the first internet protocol address and the second internet protocol address is an address of internet protocol version 6, the first internet protocol address has a first interface identifier different from a second interface identifier of the second internet protocol address, and the method comprises
providing one prefix to the terminal to be used for both the first internet protocol and the second internet protocol address.

33. The method according to claim 32, wherein
the distributing is adapted to distribute the data of the flow based on the first interface identifier and the second interface identifier if the bearer resource modification command comprises the relevance indicator.

34. The method according to claim 33, wherein
the distributing is adapted to distribute the data of the second flow to the second data path and not to the first data path based on the prefix and disregarding the first interface identifier and the second interface identifier if the further filter does not comprise the relevance indicator.

35. A computer program product embodied on a non-transitory computer-readable medium, said product comprising a set of instructions which, when executed on an apparatus, is configured to cause the apparatus to carry out the method according to claim 18.

36. (canceled)
